(19) United States
(12) Patent Application Publication
(10) Pub. No.: US 2006/0020696 A1
(43) Pub. Date: Jan. 26, 2006

(54) Wireless remote control system and method thereof

(76) Inventors: Fang-Pang Lin, Hsinchu (TW); Po-Wen Chen, Hsinchu (TW)

Correspondence Address: RABIN & BERDO, P.C., Suite 500, 1101 14 Street, N.W., Washington, DC, 20005, US

(21) Appl. No.: 10/893,919

(22) Filed: Jul. 20, 2004

(51) Int. Cl. G06F 15/173

(52) U.S. Cl. 709/224

(57) ABSTRACT

A wireless remote control system and method thereof use a server for real-time controlling a remote monitoring device and a register. When the data retrieved by the remote monitoring device, such as image, voice or text data are abnormal, the register sends an informing message to the server to request a parameter correction so as to keep the data correctness. In order to complete the data retrieving, the register stores the data until a predetermined time is up. Releasing the registered data from the register to the server when the predetermined time is up allows the reduction of mistaken data transmission.

### BACKGROUND OF THE INVENTION

1. Field of Invention

The present invention relates to a data processing system and its method, and more particularly, to a system and a method of controlling a remote device by using a server and a wireless LAN.

2. Related Art

A remote control system allows the user to monitor and control remote devices via a user interface of a local site device. Since the remote control system is not affected by time and location, it offers all-day monitoring, controlling and management. Therefore, the applications of the remote control system have been broadened.

However, in some specific remote control systems, such as ecological field research, the data transmission of the remote control system is often blocked due to the topography. This is because the remote control system uses a wire network for data transmission. Not only building the wire network is difficult, the data transmission failure also frequently results from the break down of the wiring. Furthermore, since the remote device is far away from the local site device, the transmission and retrieving of real-time data is unstable, causing data incompleteness. Furthermore, the conventional remote control system lacks an effective real-time feeding-back mechanism, which cannot immediately inform the user when any error occurs during data transmission or retrieving.

Therefore, there is a need for a remote control system that overcomes the prior problems, improves data monitoring, controlling and management, and increases its performance and stability by adding a data correcting and improved mechanism.

### SUMMARY OF THE INVENTION

It is therefore an objective of the invention to provide a wireless remote control system and process that can overcome the prior problem. The remote control system implements wireless LAN and uses a user interface to allow the user to complete all the monitoring procedures. Furthermore, a data comparison mechanism, a device real-time correction mechanism and a data feed back mechanism are included for data retrieving and transmitting.

In the data comparison mechanism, it is determined whether retrieved data are corrected via data analysis and parameter comparison. Thereby, the data correctness is ensured and incorrect data retrieving is avoided.

In the device real-time correction mechanism, when the data retrieved by the remote device are not correct, the user is immediately informed and it is requested to correct the parameters of the device. Therefore, the remote device can be corrected in a short time to reduce error operation and obtain complete data retrieving.

In the data feed back mechanism, using a predetermined time parameter controls the intervals between each time of remote fed back data. This allows safe fed back data that should be limited to geographical factor, and further makes sure the data completeness.

In addition to the above mechanisms, the remote control system further includes an Application Programming Interface (API) to link with application programs for data share and extended application range.

In order to achieve the above and other objectives, the remote control system of the invention includes a remote monitoring device, a register, and a local site server, having a user interface and a database.

The remote control process of the invention includes initializing the server, real-time retrieving data by the monitoring device. When the data retrieved by the register are correct and the predetermined time setting is up, the retrieved data are fed back to the server. When a termination command is received, the process ends.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow illustration only, and thus is not limitative of the present invention, and:

FIG. 1 is a schematic block diagram of a remote control system according to one embodiment of the invention;

FIG. 2 is a flowchart of a remote control process according to one embodiment of the invention;

FIG. 3 is a flowchart of an initialization of a server according to one embodiment of the invention;

FIG. 4 is a flowchart of parameter correction according to one embodiment of the invention;

FIG. 5 is a schematic view of the operation of parameter correction according to one embodiment of the invention;

FIG. 6A and FIG. 6B are schematic views of real-time monitoring by a user interface of a remote control system according to one embodiment of the invention; and

FIG. 7 is a schematic view of a data analysis performed by an external application program, connected to a remote control system, according to one embodiment of the invention.

### DETAILED DESCRIPTION OF THE INVENTION

The invention provides a wireless remote control system and a process thereof. A remote control system 100 of the invention includes a local site server 30, a remote site monitoring device 10 and a register 20. The remote control system 100 is implemented via wireless LAN.

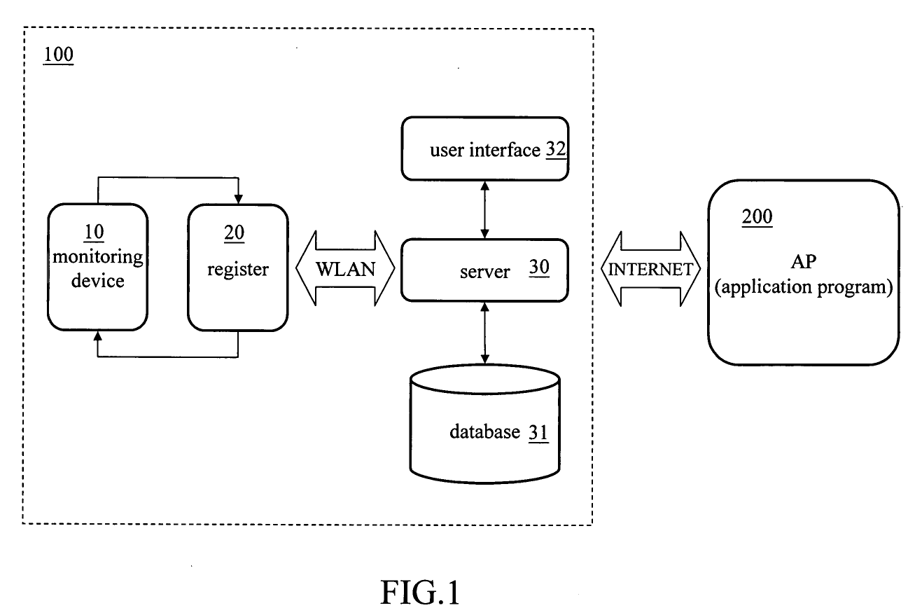

FIG. 1 is a schematic view of the operation of a remote control system 100 according to one embodiment of the invention.

The remote site monitoring device 10 connects to the register 20 and performs real-time data retrieving of an object according to parameters transmitted from the local site server 30. The monitoring device 10 includes various data retrieving modules for different types of data retrieving such as image retrieving, voice retrieving, text retrieving, etc.

The register 20 connected to the monitoring device 10 performs analyzing, registering and transmitting of data from the monitoring device 10 according to the settings of the server 30. The data and parameter settings are transmitted via wireless LAN. The communication between the register 20 and the server 30 is conducted via wireless LAN. While the register 20 performs a data analysis and comparison, when an incorrect data are found, a correcting request is sent to the server 30, to ask the user to execute a parameter correction to reduce data incorrectness. Furthermore, the register 20 temporarily saves the data retrieved by the monitoring device 10. The register 20 does not release the data to the server 30 until a predetermined time is up, so that any error due to real-time transmission is avoided and the data completeness is increased.

The server 30 performs data transmission and information communication via the wireless LAN and the register. The server 30 real-time controls the remote site monitoring device 10 and stores fed-back data. The server 30 includes a database 31 and a user interface 32.

The database 31 stores the fed-back data. In one embodiment of the invention, the database 31 is a multimedia database that is capable of storing at least one type of data.

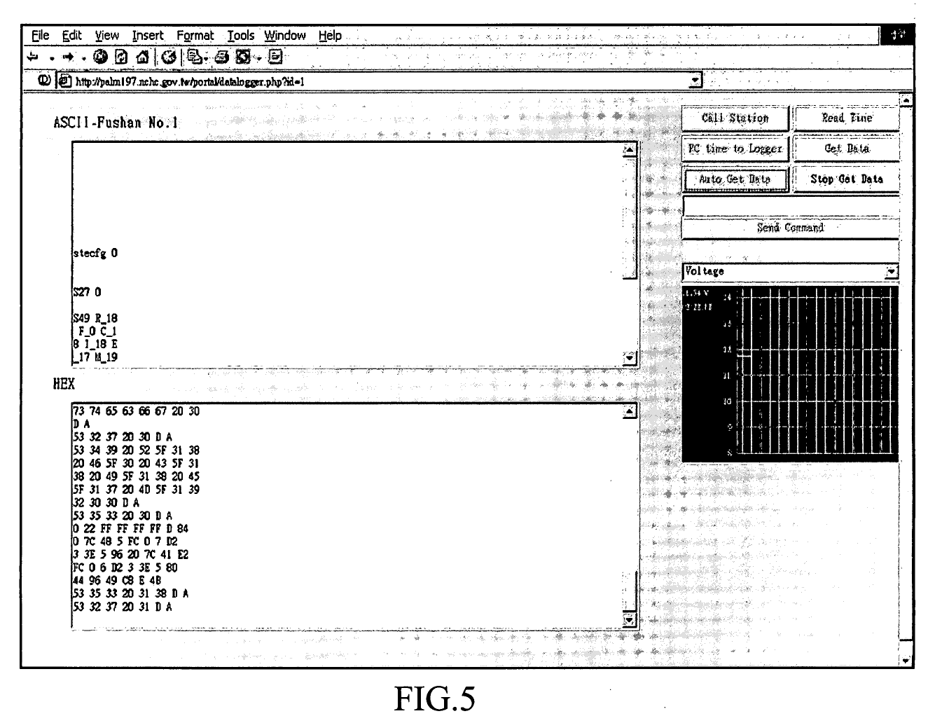

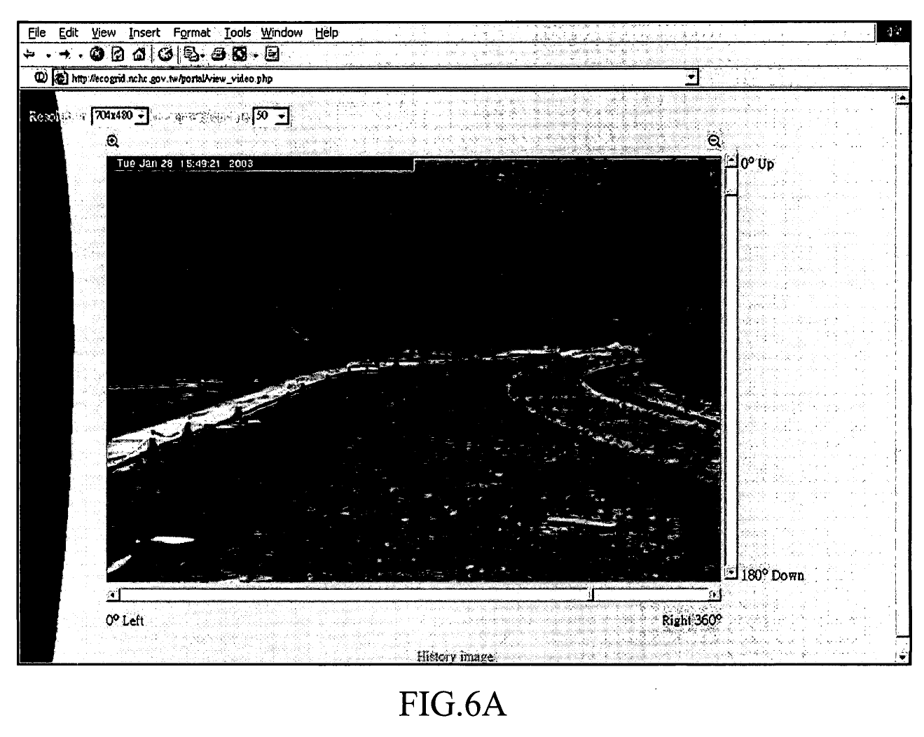

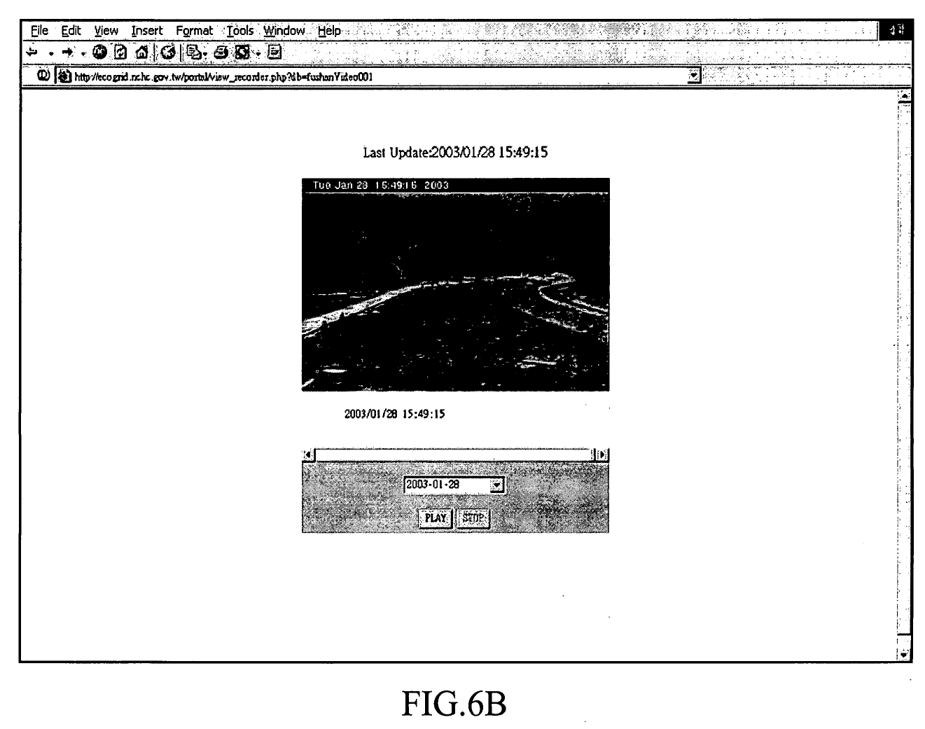

The user interface 32 enables the user to make the parameter settings. In one embodiment of the invention, the user interface 32 is a web-based interface and provides JAVA-compatible display. Via the user interface 32, the user can set the parameters of each remote device such as the monitoring device 10 and the register 20 (as shown in FIG. 5) and real-time display of the data from the register 20 (as shown in FIG. 6A) or periodically display of the data from the server 30 (as shown in FIG. 6B). The type of data displayed and the manner to display the data are not limited to those described above.

The remote control system 100 has a specific feature in the parameter settings when the system is initialized. The parameter settings include at least one initial parameter for controlling the monitoring device 10 or the register 20 so that each remote device can normally operate when the remote control system 100 is initialized. In general, the settings include those for retrieving data by the monitoring device 10, such as an image viewing angle, resolution, and voice sampling frequency, or those for operating the register 20, such as the capacity and the intervals between the registered data. The settings further include two other features: a comparison parameter and a time parameter.

The comparison parameter is used to determine the data correctness when the register 20 analyzes the data. When the analysis result exceeds the comparison parameter, it means that the compared data are not correct and need correction.

The time parameter is used to control whether the register 20 feeds back the registered data to the server 30. When the time set by the time parameter is up, the registered data are fed back to the server 30.

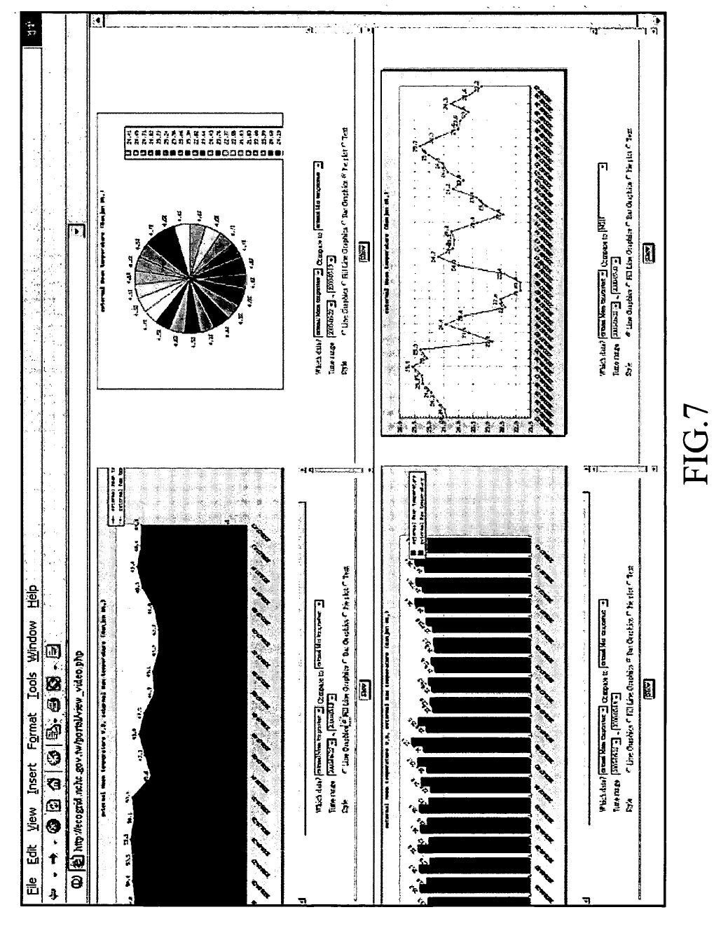

The remote control system 100 can be further combined with other applications programs 200 to share the data. The server 30 has an Application Programming Interface (API) to connect to an external application program 200 via INTERNET to retrieve any type of data from the database 31. After the application program 200 has retrieved the data, respective analysis can be performed as shown in FIG. 7.

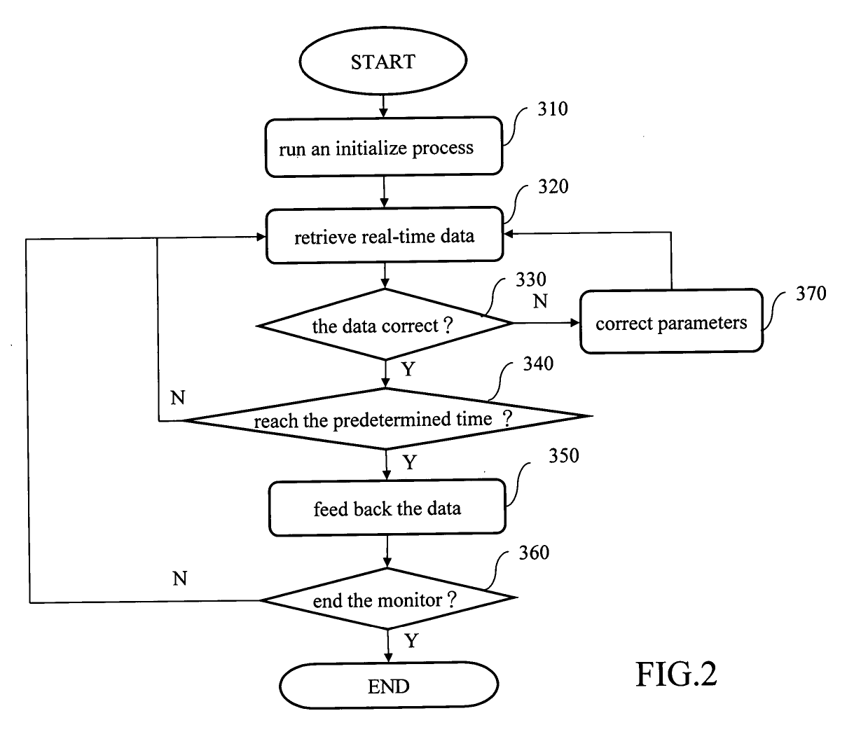

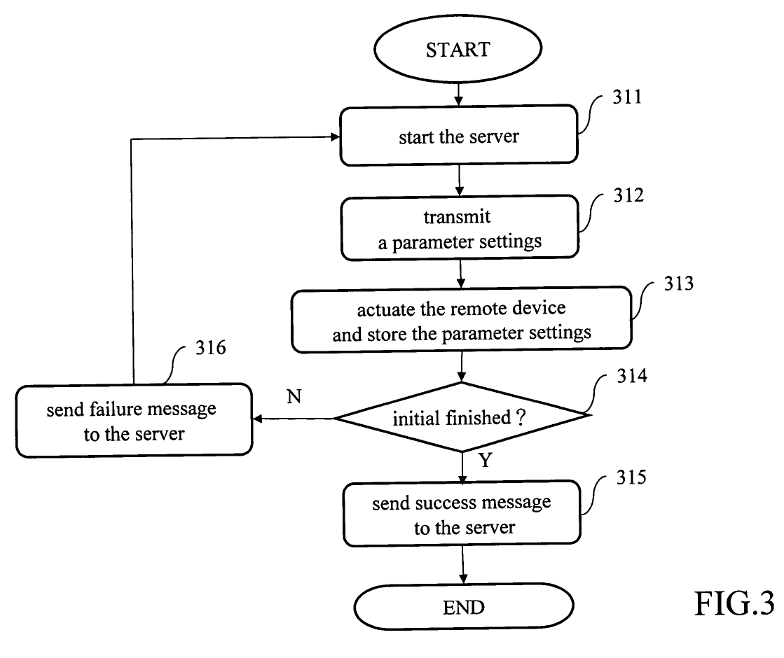

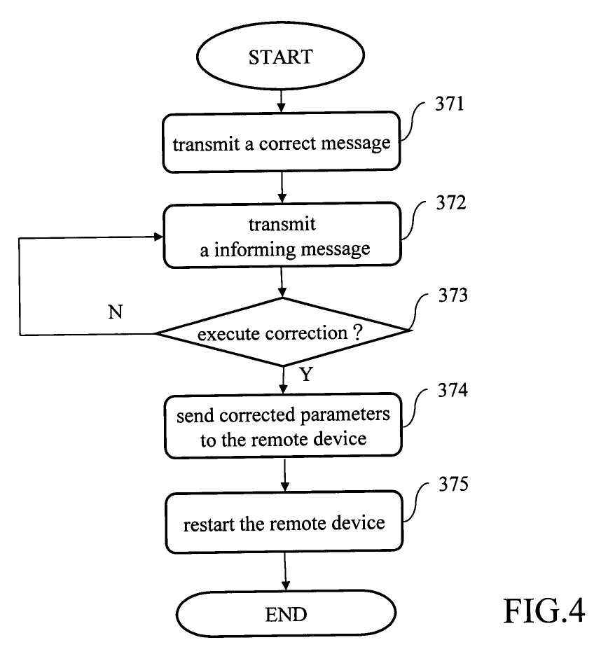

FIG. 2 is a flowchart of a remote controlling process according to one embodiment of the invention. The server is initialized (step 310) which is described later with reference to FIG. 3. After initialization, the monitoring device 10 starts data retrieving (step 320). The retrieved data include at least one type of data such as an image, voice or text. During data retrieving, the register 20 continuously compares newly retrieved data with the comparison parameter to determine whether the retrieved data are correct (step 330). If the retrieved data are not correct, then go to step 370 to execute parameter correction. FIG. 4 illustrates the detailed description of the step 370. Otherwise, the retrieved data are determined whether the time set by the time parameter is up (step 340). If the time is not up, then the retrieved data are stored in the register and the process goes back to step 320 for continuously retrieving the real-time data. If the time is up, then the registered data are sent back to the server 30 (step 350). In this process, the steps 320 to 350 repeat until the remote control system 100 receives a termination command to end the operation (step 360).

At the step 310, when the initialization begins to enter the parts of FIG. 3, the remote control system 100 partially actuates parts of the server 30 (step 311), including actuating the user interface 32. The server 30 transmits the parameter settings to the remote site monitoring device 10 and the register 20 (step 312). The user completes the parameter settings via the user interface 32. At least one parameter is used for the initialization of the monitoring device 10 and the register 20. The monitoring device 10 and the register 20 are actuated after receiving the initialization parameters and other parameters such as the comparison parameter and the time parameter are stored (step 313). The comparison parameter is used to determine the data correctness. The time parameter is used to control when the register transmits the registered data back to the server 30. Finally, it is determined whether the initialization is complete or not (step 314). If the initialization is complete, then a success message is transmitted to the server 30 (step 315). Otherwise, a failure message is transmitted to the server 30 (step 316) and then the process goes back to the step 311 to re-initialize the server 30.

FIG. 4 is a flow chart of the data correction of step 370. The register 20 transmits a data correction message to the server 30 (step 371). After receiving the massage, the server 30 immediately informs the user (step 372) to warn the user that the data are incorrect and ask the user to correct the parameters via the user interface 32. The way of informing the user by the server 30 includes an e-mail or a short message. Then, it is determined whether the user has executed the data correction (step 373). If the correction has to be done, then the corrected parameters are transmitted to the remote device (step 374). Otherwise, the step 372 is repeated. After the register 20 and the monitoring device 10 receive the new parameters, the old parameters are updated and re-start the process (step 373). Thereby, the data incorrectness can be avoided.

The process of the invention further includes a step to connect to other application programs 200 via INTERNET. The API of the server 30 connects to an external application program 200 to retrieve any type of data stored in the server 30.

Data transmission and information communication between the server 30 and the register 20 are performed via the wireless LAN. The link between the server 30 and other application programs 200 is also performed via the wireless LAN.

It will be apparent to the person skilled in the art that the invention as described above may be varied in many ways, and notwithstanding remaining within the spirit and scope of the invention as defined in the following claims.

What is claimed is:

1. A wireless remote control system, comprising:
a server, for real-time controlling a remote device and store a data, further comprising:
a user interface, used to setup the parameter settings of the remote device; and
a database, used to store the data;
a monitoring device, used to retrieve the data according the parameter settings; and
a register, for analyzing, storing and transmitting the data from the monitoring device according to the parameter settings;
wherein the data transmission and information communication between the server and the register are performed via a wireless LAN.

2. The system of claim 1, wherein the server further comprising at least one Application Programming Interface (API) for data transmission to other application programs via the INTERNET.

3. The system of claim 1, wherein the data includes at least one data type.

4. The system of claim 1, wherein the user interface is web-based and JAVA-compatible.

5. The system of claim 1, wherein the parameter settings include at least one initialization parameter for the initialization of the monitoring device and the register.

6. The system of claim 1, wherein the parameter settings include a comparison parameter for determining the data correctness by the register.

7. The system of claim 1, wherein the parameter settings include a time parameter for determining when the register feeds back the data.

8. A remote control method, applied to monitor a remote register and a remote monitoring device by a server, the monitoring device connecting to the register, the data transmission and the information communication between the register and the server being performed via a wireless LAN to real-time control the remote devices and store a data, the method comprising the following steps of:
initializing the server;
retrieving the data by the monitoring device in real-time; and
determining the data correctness stored in the register:
feeding back the data when the data is correct, and a predetermined time set is up; and
retrieving the data when the data is correct but the predetermined time set is not up.

9. The method of claim 8, wherein the data includes at least one data type.

10. The method of claim 8, wherein the step of initializing the server further comprising the following steps of
startting the server;
transmitting a parameter settings from the server;
actuating the monitoring device and the register and store the parameter settings; and
transmitting a success message to the server when the initialization is complete.

11. The method of claim 10, wherein the parameter settings include at least one initialization parameter for the initialization of the monitoring device and the register.

12. The method of claim 10, wherein the parameter settings include a comparison parameter for determining the data correctness by the register.

13. The method of claim 10, wherein the parameter settings include a time parameter for determining when the register feeds back the registered data.

14. The method of claim 8, wherein when the initialization of the server fails, a failure message is transmitted to the server and a re-start initialization process is started.

15. The method of claim 8, wherein when the register determines the retrieved data is not correct, a parameter correction process is executed.

16. The method of claim 15, wherein the parameter correction process further comprises the following steps of:
transmitting a correction message from the register to the server;
transmitting an informing message from the server;
sending a corrected parameter to the register and the monitoring device after a user performs the parameter correction on the server; and
restarting the register and the monitoring device after the register and the monitoring device have received and updated the corrected parameter settings.

17. The method of claim 16, wherein when the user does not execute the correction on the server, the server continues to inform the user by transmitting the informing message.

18. The method of claim 16, wherein the informing message is in the format of e-mail.

19. The method of claim 16, wherein the informing message is in the format of short message.

20. The method of claim 8, further comprising at least one Application Programming Interface (API) for data transmission to other application programs via INTERNET.
